(19) United States
(12) Patent Application Publication
(10) Pub. No.: US 2004/0117384 A1
(43) Pub. Date: Jun. 17, 2004

(54) Item delivery service with return component

(76) Inventor: Christine R.L. Ray, Washington, DC (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/476,000

(22) PCT Filed: Apr. 26, 2002
(86) PCT No.: PCT/US02/11859

(30) Foreign Application Priority Data
Apr. 27, 2001 (US) 60286540

(51) Int. Cl. G06F 17/00

(52) U.S. Cl. 707/100

(57) ABSTRACT

Providing item delivery service with a return component comprises arranging, by third party, a sales transaction of an item (110) between a seller (105) and a buyer (155) and delivering the item to the buyer utilizing a delivery system (100). Next, providing item delivery service includes making a payment for at least one of the following: a purchase price of the item, a delivery fee, and a fee for any upon a determination by the buyer as to whether to keep the item after an inspection of the item. And finally, providing item delivery service includes returning the item to the seller through the delivery system if the buyer determined not to keep the item, the third party providing the buyer with the return label.

### RELATED APPLICATIONS

Under provisions of 35 U.S.C. §119(e), Applicant claims the benefit of U.S. provisional application No. 60/286,540, filed Apr. 27, 2001, which is incorporated herein by reference. U.S. provisional application No. 60/230,798 entitled “Integration of Person to Person Internet Payment System with a Shipping and Merchandise Return Component,” filed Sep. 7, 2001, and PCT application no. PCT/US01/27567 entitled “Systems and Methods for Providing Item Sales and Delivery Service,” filed Sep. 6, 2001, are both hereby incorporated by reference.

### TECHNICAL FIELD

The present invention relates to the field of providing item delivery service. More particularly, the present invention, in various specific embodiments, involves methods and systems for delivering items through an item delivery system with a return component.

### BACKGROUND

The United States Postal Service (USPS) is an independent government agency that provides mail delivery and other services to the public. The USPS is widely recognized as a safe and reliable means for sending and receiving mail and other items. With the advent and steady growth of electronic mail and electronic commerce, the physical mail stream will increasingly be utilized for sending and receiving packages. In the context of electronic commerce, specifically where a seller has an item to sell and a buyer has a need for the item, the sale of the item may require facilitation from a third party for financial arrangements or for delivery of the item. For example, if an agreement to sell an item is made remotely between a seller and buyer who are complete strangers or otherwise have no trust in the other party's ability to perform their respective portions of the arrangement, a trusted third party may provide a means to transfer payment for the item or to provide delivery of the item.

Therefore, the need to efficiently provide item sales and delivery service has become a common need for the United States Postal Service and many other organizations. More specifically, efficiently delivering items through an item delivery system between a seller and a buyer with a return component has become a critical service for many delivery system operators. This is because in an increasingly competitive environment, meeting and exceeding the expectations of those who receive a service is essential for a service provider.

One solution to the item sales and delivery service problem is for the seller and buyer to use a person-to-person payment system, for example, over the Internet. In this situation, a buyer agrees to buy an item online from another individual, for example, at an online auction site. After the agreement as to the sale is made, the buyer must send a payment to the seller. Typically, the person-to-person payment system handles in the background the payment transaction, for example, a debit to the buyer and a credit to the seller via credit card. Once the seller's account is credited, the person-to-person payment system can notify the seller via e-mail that the person-to-person payment system has the funds secured. In a normal a person-to-person payment system, this is the end of the procedure.

Great inefficiencies are created in this procedure because, for example, the delivery component of the procedure is not coordinated with the financial aspects of the procedure. Accordingly, efficiently providing item delivery service remains an elusive goal. Thus, there remains a need for efficiently providing item delivery service. In addition, there remains a need for efficiently delivering items through an item delivery system between a seller and a buyer with a return component.

### SUMMARY OF THE INVENTION

In accordance with the current invention, an item delivery service method and system are provided that avoid the problems associated with prior art item delivery service methods and systems as discussed herein above.

In one aspect, a method for providing item delivery service with a return component comprises arranging, by a third party, a sales transaction of an item between a seller and a buyer, delivering the item to the buyer utilizing a delivery system, making a payment for at least one of the following: a purchase price of the item, a delivery fee, and a fee for any other buyer-selected delivery-related services based at least upon a determination by the buyer as to whether to keep the item after an inspection of the item, and returning the item to the seller through the delivery system if the buyer determined not to keep the item, the third party providing the buyer with a return label.

In another aspect, a system for providing item delivery service with a return component comprises a component for arranging, by a third party, a sales transaction of an item between a seller and a buyer, a component for delivering the item to the buyer utilizing a delivery system, a component for making a payment for at least one of the following: a purchase price of the item, a delivery fee, and a fee for any other buyer-selected delivery-related services based at least upon a determination by the buyer as to whether to keep the item after an inspection of the item, and a component for returning the item to the seller through the delivery system if the buyer determined not to keep the item, the third party providing the buyer with a return label.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a functional block diagram of an exemplary system for providing item delivery with a return component consistent with an embodiment of the present invention;

FIG. 2 is a flow chart of an exemplary method for providing item delivery with a return component consistent with an embodiment of the present invention;

FIG. 3A is a flow chart of an exemplary subroutine used in the exemplary method of FIG. 2 for arranging, by a third party, a sales transaction of an item between a seller and a buyer consistent with an embodiment of the present invention;

FIG. 3B is a flow chart of an exemplary alternative embodiment of the exemplary subroutine of FIG. 3A used in the exemplary method of FIG. 2 for arranging, by a third party, a sales transaction of an item between a seller and a buyer consistent with an embodiment of the present invention;

FIG. 4 is a flow chart of an exemplary subroutine used in the exemplary method of FIG. 2 for delivering the item to the buyer consistent with an embodiment of the present invention; and

FIG. 5 is a flow chart of an exemplary subroutine used in the exemplary method of FIG. 2 for returning the item to the seller through the delivery system if the buyer determined not to keep the item consistent with an embodiment of the present invention.

### DETAILED DESCRIPTION

Reference will now be made to various embodiments according to this invention, examples of which are shown in the accompanying drawings and will be obvious from the description of the invention. In the drawings, the same reference numbers represent the same or similar elements in the different drawings whenever possible.

Consistent with an embodiment of the present invention, a system for providing item delivery service with a return component may comprise a component for arranging, by a third party, a sales transaction of an item between a seller and a buyer, a component for delivering the item to the buyer utilizing a delivery system, a component for making a payment for at least one of the following: a purchase price of the item, a delivery fee, and a fee for any other buyer-selected delivery-related services based at least upon a determination by the buyer as to whether to keep the item after an inspection of the item, and a component for returning the item to the seller through the delivery system if the buyer determined not to keep the item, the third party providing the buyer with a return label.

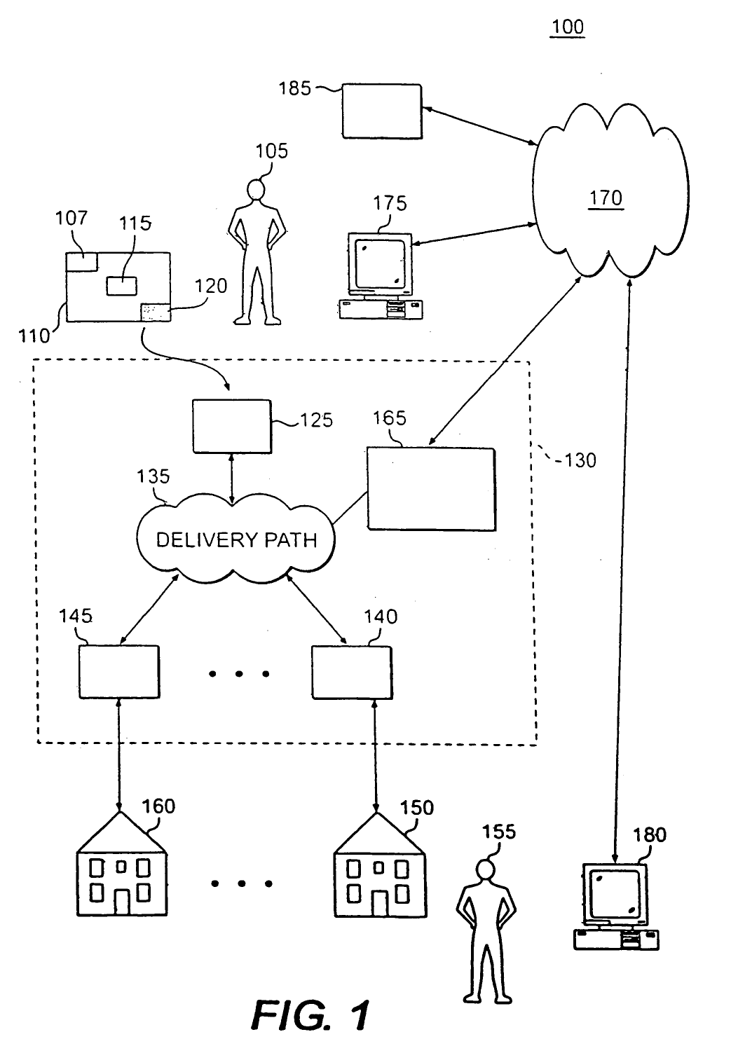

Consistent with an embodiment of the invention, the component for arranging a sales transaction and the component for making a payment may comprise a seller computer 175, buyer computer 180, or a person-to-person system 185, all of which are shown in FIG. 1 and described below. In addition, the component for delivering the item and the component for returning the item may comprise a delivery system 130, which also is shown in FIG. 1 and described below. Those of ordinary skill in the art, however, will appreciate that other elements of system 100 may comprise the component for arranging a sales transaction, the component for making a payment, the component for delivering the item, and the component for returning the item.

In addition, the third party may include a person-to-person payment system or a delivery system operator. However, those of ordinary skill in the art will appreciate that other entities or enterprises may comprise the third party.

Referring to FIG. 1, an embodiment consistent with the present invention provides an item delivery system 100. For example, a buyer 155 may elect to purchase an item 110 from a seller 105. In arranging this purchase, a communications system 170, for example, the Internet, may be employed to facilitate buyer 155 and seller 105 agreeing to item 110 and a price for item 110. An online auction site, for example, may be used for this function. In addition to this type of arrangement, buyer 155 may elect to pay for the purchase and delivery of item 110 using person-to-person system 185, also utilizing communications system 170. In this example, in order to pay for item 110, buyer 155 may authorize person-to-person system 185 to transfer payment from a buyer account. The payment may include a purchase price of item 110, a delivery fee, and a fee for other buyer-selected delivery-related services.

Person-to-person system 185 may then debit the buyer account in the amount of the payment and place the payment debited from the buyer account into an escrow account. Person-to-person system 185 may then send a notice, for example, an e-mail, to seller 105 over communications system 170 indicating that item 110 can be shipped. After the delivery system operator notifies person-to-person system 185 over communications system 170 that the item 110 has been delivered, person-to-person system 185 may then make a payment for at least one of the following: the purchase price of item 110, the delivery fee, and the fee for any other buyer-selected delivery-related services. Specifically, if buyer 155 decides after receipt not to keep item 110, person-to-person system 185 may then make the payment of the purchase price of the item 110 to buyer 155. If buyer 155, however, decides after receipt to keep item 110, person-to-person system 185 may then make the payment of the purchase price of item 110 to seller 105. In any event, the delivery fee and the fee for any other buyer-selected delivery-related services may be paid by person-to-person system 185 to a delivery system operator.

Seller 105 may place item 110 into delivery system 130. Item 110 may contain a label 115 indicating a first address 150 of buyer 155 and a return address 107 indicating where to return item 110 if necessary. Item 110 may also contain a tracking indicia 120 identifying the sales transaction, relating seller 105 and buyer 155. Tracking indicia 120 may be placed on item 110 by seller 105 or the delivery system operator.

Item 110 is routed through delivery system 130, which may comprise a seller plant 125, a delivery path 135, a first address plant 140, an alternative address plant 145, and an alternative processing point 165. Delivery path 135 may comprise a plurality of plants similar to seller plant 125, first address plant 140, and alternative address plant 145. The plants within delivery path 135 may contain, among other things, automated systems and sorting equipment and are designed to receive and process a plurality of items. Delivery system 130 may be configured to sense tracking indicia 120 placed on item 110 as it passes through the elements of delivery system 130 directing the movement of item 110 through delivery system 130. In addition to facilitating the tracking of item 110 through delivery system 130, tracking indicia 120 identifies the sales transaction and relates buyer 155 and seller 105.

Tracking indicia 120 may comprise a bar code or a PLANET code. A bar code is a printed code used for recognition by a bar code scanner (reader). Traditional one-dimensional bar codes use the bar's width to encode a product or account number. Two-dimensional bar codes, such as PDF417, MAXICODE and DATAMATRIX, are scanned horizontally and vertically and hold considerably more data. Generally, PDF417 is widely used for general purposes, MAXICODE is used for high-speed sorting, and DATAMATRIX is used for marking small parts.

Historically, system operators sorted flat mail using POSTNET, a 12-digit barcode consisting of alternating long and short bars indicating the destination of, for example, a mailpiece. Responding to the expanding needs of users, particularly heavy volume users, PLANET code was developed on the foundation of the existing technical infrastructure. The PLANET Code is the opposite of the current POSTNET codes, reversing long bars for short and short bars for long. This innovation offers the convenience of a bar code that is easily applied using current bar-coding methods, and is readily scanned by the high-speed automation equipment already located in the plurality of plants comprising delivery system 130.

Item 110 may be sent through delivery system 130 by seller 105 to first address plant 140. At anytime in the delivery process a determination may be made as to whether item 110 is undeliverable. If it is determined that item 110 is undeliverable, item 110 may be forwarded to alternative processing point 165 where an ancillary service may be performed. Examples of such ancillary services are recycle service (treating item 110 as waste). NIXIE service, and Computerized Forwarding Service (CFS).

With respect to NIXIE service, NIXIE is a classification given to an item that cannot be sorted or is undeliverable-as-addressed because of an incorrect, illegible, or insufficient delivery address. If item 110 is undeliverable-as-addressed, address correction service (re-label with a correct address) or return service (return item to the sender) may be performed. In this case, a NIXIE operator specialized in the handling of such items is required. If item 110 requires return service, return address 107 on item 110 is read and item 110 is sent to return address 107 accordingly. Return address 107 is an element of item 110 that is usually placed in the upper left corner of item 110 to indicate the address of seller 105. This address indicates where seller 105 wants item 110 returned if it is undeliverable. In addition return address 107 may indicate where seller 105 will receive a bill for any fees due for the return of item 110. When item 110 requires address correction service, a NIXIE operator obtains the proper address of buyer 155 or the reason for nondelivery. While NIXIE processing may comprise address correction service or return service, those skilled in the art will appreciate that may other types of NIXIE processing may be performed.

Computerized forwarding service is a centralized, computerized address label-generating operation that forwards undeliverable-as-addressed items to buyers. In this case, buyer 155 may pre-register an alternative address 160 of buyer 155 with the delivery system operator in order to have all items forwarded to alternative address 160. For example, if buyer 155 moves and wishes to have items sent to alternative address 160, buyer 155 notifies the delivery system operator of alternative address 160. Once the delivery system operator is notified of alternative address 160, all items sent to first address 150 are detected by delivery system 130, re-labeled, and then forwarded to alternative address 160. In the aforementioned computerized forwarding service, items are forwarded only for a specific period of time. The delivery system operator expects buyer 155 to contact each and every seller who buyer 155 may expect to receive an item and notify the possible sellers of the address change of buyer 155. After the computerized forwarding service time period is complete, the delivery system operator will cease forwarding items to buyer 155 and will return to the seller 105 all items sent to first address 150.

If ancillary services were required, item 110 may remain at alternative processing point 165 or may be processed at an item recovery section of alternative processing point 165. Item 110 may be recovered by seller 105 or buyer 155 upon the completion of a tracer. A tracer is a form completed by seller 105 or buyer 155 to locate delayed or undelivered items. While item recovery may occur at alternative processing point 165, those skilled in the art will appreciate that may other types of processing may be performed at alternative processing point 165. While person-to-person system 185 is shown to be separate from delivery system 130, the functionality of person-to-person system 185 may be performed under the control of the delivery system operator at alternative processing point 165, at any point within delivery system 130 or at any point outside delivery system 130.

Still referring to FIG. 1, person-to-person system 185, the delivery system operator, seller 105, and buyer 155 may communicate with each other over communications system 170. An embodiment of the present invention may utilize seller computer 175, buyer computer 180, delivery system operator computer (not shown), and person-to-person system computer (not shown) contained within person-to-person system 185. These computers may be typically personal computers or other similar microcomputer-based workstations. Those skilled in the art, however, will appreciate that seller computer 175, buyer computer 180, delivery system operator computer, and person-to-person system computer may comprise any type of computer operating environment such as hand-held devices, multiprocessor systems, microprocessor-based or programmable consumer electronics, minicomputers, mainframe computers, and the like. These computers may also be implemented in distributed computing environments where tasks are performed by remote processing devices and have the capability of connecting to communications system 170.

If the Internet is utilized as communications system 170, this connection can be made utilizing e-mail generally through the use of a standard e-mail software package such as Microsoft Corporation's OUTLOOK or GROUPWISE marketed by Novell, Inc. In this example where communications system 170 is the Internet, any notices, arrangements, communications, or general exchange of information may be accomplished via e-mail. Seller computer 175, buyer computer 180, the delivery system operator computer, and the person-to-person system computer may connect to the Internet through an Internet service provider (ISP) (not shown) in the manner known to those skilled in the art. In addition to Internet based e-mail, person-to-person system 185, the delivery system operator, seller 105, and buyer 155 may communicate over communications system 170 utilizing regular mail, facsimile, web pages, or an interactive voice response systems. Those of ordinary skill in the art will appreciate that many other types of communications system 170 may be used.

In addition to utilizing a wire line communications system 170, a wireless communications system 170 or a combination of wire line and wireless may be utilized in order to exchange e-mails via the Internet or for utilizing other communications media. Wireless can be defined as radio transmission via the airwaves, however, those skilled in the art will appreciate that various other communication techniques can be used to provide wireless transmission including infrared line of sight, cellular, microwave, satellite, packet radio, and spread spectrum radio. Seller computer 175, buyer computer 180, delivery system operator computer, and person-to-person system computer in the wireless environment can be any mobile terminal such as a smart phone, personal digital assistant (PDA), intelligent pager, portable computer, hand held computer, or any device capable of receiving wireless data. Wireless data may include, but is not limited to, paging, text messaging, e-mail, Internet access, and other specialized data applications specifically excluding voice transmission. A PDA is a handheld computer that serves as an organizer for personal information. It generally includes at least a name and address database, to-do list, and note taker. PDAs are typically pen based and use a stylus to tap selections on menus and to enter printed characters. The unit may also include a small on-screen keyboard which is tapped with the pen. Data may be synchronized between the PDA and a desktop computer through a cable or wireless transmissions.

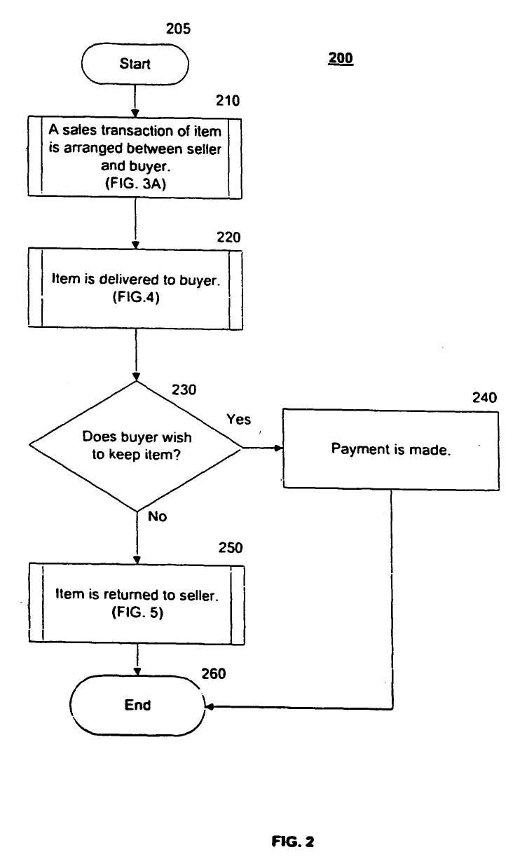

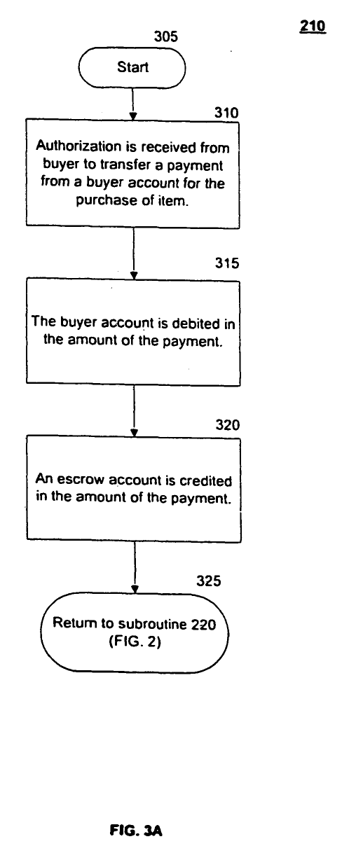

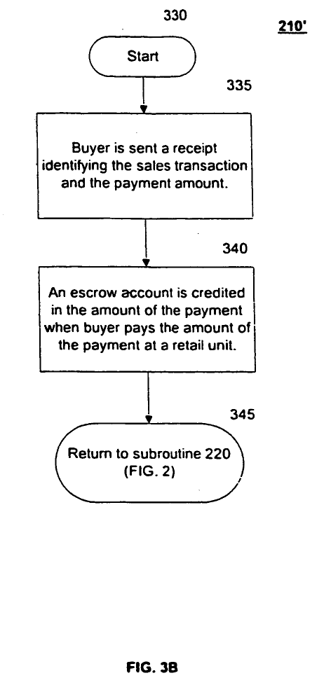

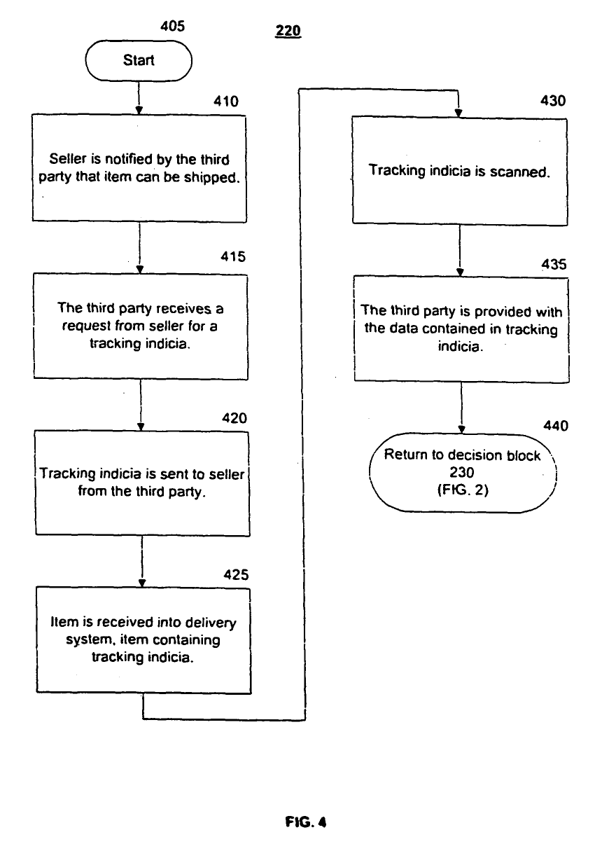

FIG. 2 is a flow chart setting forth the general stages involved in exemplary method providing item delivery with a return component consistent with an embodiment of the present invention. The implementation of the stages of exemplary method 200 in accordance with an exemplary embodiment of the present invention will be described in greater detail in FIG. 3 through FIG. 5. Exemplary method 200 begins at starting block 205 and proceeds to exemplary subroutine 210 where a sales transaction of item 110 is arranged between seller 105 and buyer 155. The stages of exemplary subroutine 210 are shown in FIG. 3A and will be described in greater detail below. The stages of exemplary subroutine 210′, which is an alternate embodiment of subroutine 210, are shown in FIG. 3B and will also be described in greater detail below. From exemplary subroutine 210 where a sales transaction of item 110 is arranged between seller 105 and buyer 155, exemplary method 200 continues to exemplary subroutine 220 where item 110 is delivered to buyer 155. The stages of exemplary subroutine 220 are shown in FIG. 4 and will be described in greater detail below.

Once a sales transaction of item 110 is arranged between seller 105 and buyer 155 in exemplary subroutine 220, exemplary method 200 advances to decision block 230 where it is determined if buyer 155 wishes to keep item 110. For example, the delivery system operator may deliver item 110 to buyer 155. Buyer 155 may open item 110 and inspect it within, for example, a predetermined period of time to determine whether to keep item 110.

If at decision block 230 it is determined that buyer 155 wishes to keep item 110, exemplary method 200 continues to stage 240 where payment is made. For example, this payment may include making the payment ef the purchase price of item 110 to seller 105 if buyer 155 decided to keep item 110, with tracking indicia 120 on item 110 identifying seller 105. Specifically, a person-to-person system may match tracking indicia 120 with a sellers customer identification number, for example, and release to seller 105 payments from the escrow account that match tracking indicia 120.

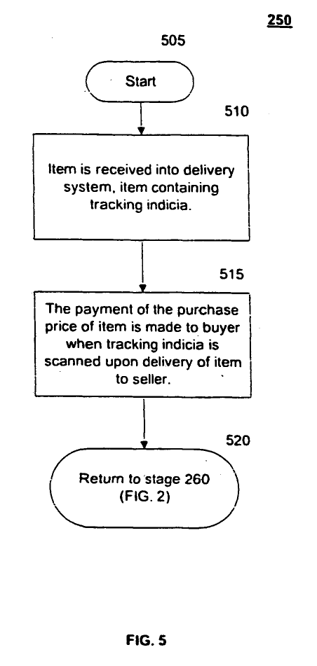

If at decision block 230, however, it was determined that buyer 155 does not wish to keep item 110, exemplary method 200 continues to exemplary subroutine 250 where item 110 is returned to seller 105. The stages of exemplary subroutine 250 are shown in FIG. 5 and will be described in greater detail below. From exemplary subroutine 250, or from stage 240, exemplary method 200 ends at stage 260.

FIG. 3A describes exemplary subroutine 210 from FIG. 2 for arranging, by a third party, a sales transaction of item 110 between seller 105 and buyer 155 consistent with an embodiment of the present invention. Exemplary subroutine 210 begins at starting block 305 and advances to stage 310 where authorization is received from buyer 155 to transfer a payment from a buyer account for the purchase of item 110. For example, buyer 105 may arrange a purchase of an item from a seller through an internet-based transaction and then elect to pay for this purchase and delivery of the item using a person-to-person payment system, which may be internet based. Buyer 155 may authorize the person-to-person payment system, for example, to transfer a payment from a buyer account. This payment may include the purchase price of the item, a delivery fee, and a fee for other buyer selected delivery related services.

Once authorization is received from buyer 155 to transfer a payment from a buyer account for the purchase of item 110 in stage 310, exemplary subroutine 210 continues to stage 315 where the buyer account is debited in the amount of the payment. For example, a person-to-person payment system may debit the buyer account in the amount of the payment

After the buyer account is debited in the amount of the payment in stage 315, exemplary subroutine 210 advances to stage 320 where an escrow account is credited in the amount of the payment. For example, a person-to-person payment system may place the payment debited from the buyer account into an escrow account.

From stage 320 where an escrow account is credited in the amount of the payment, exemplary subroutine 210 continues to stage 325 and returns to exemplary subroutine 220 of FIG. 2.

FIG. 3B describes exemplary subroutine 210′, which is an alternate embodiment of exemplary subroutine 210, for arranging, by a third party, a sales transaction of item 110 between seller 105 and buyer 155 consistent with an embodiment of the present invention. Exemplary subroutine 210′ begins at starting block 330 and advances to stage 335 where buyer 155 is sent a receipt identifying the sales transaction and the payment amount. For example, buyer 105 may arrange a purchase of an item from a seller through an internet-based transaction and then elect to pay for this purchase and delivery of the item using a person-to-person payment system, which may be internet based. A person-to-person payment system may provide buyer 155 with the receipt at the time of the online purchase of the item. The receipt may be in electronic or hardcopy form. If the receipt is in electronic form, buyer 155 may print the receipt on buyer computer 180 in order to obtain the hardcopy. The receipt may include a barcode, or other indicia, and may be in a format readable by a bill payment terminal.

Once buyer 155 is sent a receipt identifying the sales transaction and the payment amount in stage 335, exemplary subroutine 210′ continues to stage 340 where an escrow account is credited in the amount of the payment when buyer 155 pays the amount of the payment at a retail unit. For example, buyer 155 may take the receipt to a retail unit having a bill payment terminal, and may have the receipt scanned and payment made by buyer 155. The payment method used by buyer 155 may include any known payment method, such as cash, credit or debitcard, and a check.

After an escrow account is credited in the amount of the payment when buyer 155 pays the amount of the payment at a retail unit in stage 340, exemplary subroutine 210′ advances to stage 345 and returns to exemplary subroutine 220 of FIG. 2.

FIG. 4 describes exemplary subroutine 220 from FIG. 2 for delivering item 110 to buyer 155 consistent with an embodiment of the present invention. Exemplary subroutine 220 begins at starting block 405 and advances to stage 410 where seller 105 is notified by the third party that item 110 can be shipped. For example, a person-to-person payment system may send a notice, for example, an e-mail, to seller 105 indicating that item 110 can be shipped.

Once seller 105 is notified by the third party that item 110 can be shipped in stage 410, exemplary subroutine 220 continues to stage 415 where the third party receives a request from seller 105 for a tracking indicia 120. For example, seller 105 may request a delivery confirmation barcode through a person-to-person payment system. Payments that were placed in the escrow account may be identified by a unique customer identification number. This customer identification number may allow the delivery system operator to generate a file of all delivery confirmation barcodes scanned, for example, in a particular day for that customer. Each delivery confirmation barcode may be mapped to a customer based on the customer identification number.

After the third party receives a request from seller 105 for a tracking indicia 120 in stage 415, exemplary subroutine 220 advances to stage 420 where tracking indicia 120 is sent to seller 105 from the third party. For example, a person-to-person payment system may send tracking indicia 120, comprising a delivery confirmation barcode, to seller 105. Thereafter, seller 105 may receive the delivery confirmation barcode, including for example, information about the amount of money in the escrow account that is to be released to seller 105 upon delivery of item 110.

From stage 420 where tracking indicia 120 is sent to seller 105 from the third party, exemplary subroutine 220 continues to stage 425 where item 110 is received into delivery system 130, item 110 containing tracking indicia 120. For example, seller 105 may generate label 115 that may include a delivery address received from buyer 155. Seller 105 may package item 110 for shipping and may apply tracking indicia 120 and postage, for example, to item 110. Alternatively, seller 105 may transfer item 110, label 115, and tracking indicia 120 to a delivery system operator for packaging. The delivery system operator may include, for example, the United States Postal Service. Item 110 may then be placed into the mailstream, for example, either by seller 105 or the delivery service operator. The mailstream may include, for example, the mailstream provided by the United States Postal Service.

Once item 110 is received into delivery system 130 in stage 425, exemplary subroutine 220 advances to stage 430 where tracking indicia 120 is scanned. For example, the United States Postal Service may scan tracking indicia 120 on item 110 prior to delivering item 110 to buyer 155 at delivery address 150.

After tracking indicia 120 is scanned in stage 430, exemplary subroutine 220 continues to stage 435 where the third party is provided with the data contained in tracking indicia 120. For example, the delivery system operator may create and store a file containing the data stored in tracking indicia 120. A person-to-person payment system may receive the file from the delivery system operator. From stage 435 where the third party is provided with the data contained in tracking indicia 120, exemplary subroutine 220 advances to stage 440 and returns to decision block 230 of FIG. 2.

FIG. 5 describes exemplary subroutine 250 from FIG. 2 for returning item 110 to seller 105 through delivery system 130 if buyer 155 determined not to keep item 110, consistent with an embodiment of the present invention. Exemplary subroutine 250 begins at starting block 505 and advances to stage 510 where item 110 is received into delivery system 130, item 110 containing tracking indicia 120. For example, buyer 155 may request a return label from a person-to-person payment system. Thereafter, buyer 155 may receive the return label including, for example, information about seller 105, return address 107, and a new delivery confirmation barcode. The information about seller 105 may include the seller's name and other information. Thereafter, buyer 155 may repackage item 110, apply the return label to the new package and any required postage, and place the new package into delivery system 130, for example.

Once item 110 is received into delivery system 130 in stage 510, exemplary subroutine 250 continues to stage 515 where the payment of the purchase price of item 110 is made to buyer 155 when tracking indicia 120 is scanned upon delivery of item 110 to seller 155. For example, the delivery system, operator may scan tracking indicia 120 on item 110 when it is delivered to seller 105. A person-to-person payment system may match payments in an escrow account based on the data contained in the scanned tracking indicia. Thereafter, the person-to-person payment system may release from the escrow account any agreed upon fees to the seller and/or delivery system operator and release the balance to buyer 155. In addition, the person-to-person payment system may send notifications to both buyer 155 and seller 105 of the release of payments in the escrow account. This notification may be provided, for example, by e-mail.

After the payment of the purchase price of item 110 is made to buyer 155 when tracking indicia 120 is scanned upon delivery of item 110 to seller 155 in stage 515, exemplary subroutine 250 advances to stage 520 and returns to stage 260 of FIG. 2.

It will be appreciated that a system in accordance with an embodiment of the invention can be constructed in whole or in part from special purpose hardware or a general purpose computer system, or any combination thereof. Any portion of such a system may be controlled by a suitable program. Any program may in whole or in part comprise part of or be stored on the system in a conventional manner, or it may in whole or in part be provided in to the system over a network or other mechanism for transferring information in a conventional manner. In addition, it will be appreciated that the system may be operated and/or otherwise controlled by means of information provided by an operator using operator input elements (not shown) which may be connected directly to the system or which may transfer the information to the system over a network or other mechanism for transferring information in a conventional manner.

The foregoing description has been limited to a specific embodiment of this invention. It will be apparent, however, that various variations and modifications may be made to the invention, with the attainment of some or all of the advantages of the invention. It is the object of the appended claims to cover these and such other variations and modifications as come within the true spirit and scope of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

We claim:

1. A method for providing item delivery service with a return component, comprising:
arranging, by a third party, a sales transaction of an item between a seller and a buyer;
delivering the item to the buyer utilizing a delivery system;
making a payment for at least one of the following: a purchase price of the item, a delivery fee, and a fee for any other buyer-selected delivery-related services based at least upon a determination by the buyer as to whether to keep the item after an inspection of the item; and
returning the item to the seller through the delivery system if the buyer determined not to keep the item, the third party providing the buyer with a return label.

2. The method of claim 1, wherein the arranging stage further comprises:
receiving authorization from the buyer to transfer a payment from a buyer account for the purchase of the item;
debiting the buyer account in the amount of the payment; and
crediting an escrow account in the amount of the payment.

3. The method of claim 2, further comprising debiting the buyer account by at least one of the following: billing the buyer, debiting buyer's checking account, debiting buyer's credit card account, debiting buyer's debit card account, and receiving cash from the buyer.

4. The method of claim 1, wherein the arranging stage further comprises:
sending the buyer a receipt identifying the sales transaction and the payment amount; and
crediting an escrow account in the amount of the payment when the buyer pays the amount of the payment at a retail unit.

5. The method of claim 1, wherein the delivering stage further comprises:
notifying the seller by the third party that the item can be shipped;
receiving by the third party a request from the seller-for a tracking indicia; and
sending the tracking indicia to the seller from the third party.

6. The method of claim 1, wherein the delivering stage further comprises:
receiving the item into the delivery system, the item containing a tracking indicia;
scanning the tracking indicia; and
providing the third party with the data contained in the tracking indicia.

7. The method of claim 1, wherein the making stage further comprises making the payment of the purchase price of the item to the seller if the buyer decided to keep the item, a tracking indicia on the item identifying the seller.

8. The method of claim 1, wherein, if the buyer determined not to keep the item, the returning stage further comprises:
receiving the item into the delivery system, the item containing a tracking indicia; and
making the payment of the purchase price of the item to the buyer when the tracking indicia is scanned upon delivery of the item to the seller.

9. The method of claim 1, further comprising utilizing at least one of the following media: regular mail, e-mail, facsimile, internet, and an interactive voice response method in arranging the sales transaction.

10. The method of claim 1, further comprising processing the item comprising at least one of the following: a mailpiece, a United States Postal Service Priority Mail package, and a United States Postal Service Express Mail Package.

11. The method of claim 1, further comprising utilizing as a tracking indicia at least one of the following: a bar code and a PLANET code.

12. A system for providing item delivery service with a return component, comprising:
a component for arranging, by a third party, a sales transaction of an item between a seller and a buyer;
a component for delivering the item to the buyer utilizing a delivery system;
a component for making a payment for at least one of the following: a purchase price of the item, a delivery fee, and a fee for any other buyer-selected delivery-related services based at least upon a determination by the buyer as to whether to keep the item after an inspection of the item; and
a component for returning the item to the seller through the delivery system if the buyer determined not to keep the item, the third party providing the buyer with a return label.

13. The system of claim 12, wherein the component for arranging further comprises:
a component for receiving authorization from the buyer to transfer a payment from a buyer account for the purchase of the item;
a component for debiting the buyer account in the amount of the payment; and
a component for crediting an escrow account in the amount of the payment.

14. The system of claim 13, further comprising a component for debiting the buyer account by at least one of the following: billing the buyer, debiting buyer's checking account, debiting buyer's credit card account, debiting buyer's debit card account, and receiving cash from the buyer.

15. The system of claim 12, wherein the component for arranging further comprises:
a component for sending the buyer a receipt identifying the sales transaction and the payment amount; and
a component for crediting an escrow account in the amount of the payment when the buyer pays the amount of the payment at a retail unit.

16. The system of claim 12, wherein the component for delivering further comprises:
a component for notifying the seller by the third party that the item can be shipped;
a component for receiving by the third party a request from the seller for a tracking indicia; and
a component for sending the tracking indicia to the seller from the third party.

17. The system of claim 12, wherein the component for delivering further comprises:
a component for receiving the item into the delivery system, the item containing a tracking indicia;
a component for scanning the tracking indicia; and
a component for providing the third party with the data contained in the tracking indicia.

18. The system of claim 12, wherein the component for making further comprises a component for making the payment of the purchase price of the item to the seller if the buyer decided to keep the item, a tracking indicia on the item identifying the seller.

19. The system of claim 12, wherein, if the buyer determined not to keep the item, the component for returning further comprises:
a component for receiving the item into the delivery system, the item containing a tracking indicia; and
a component for making the payment of the purchase price of the item to the buyer when the tracking indicia is scanned upon delivery of the item to the seller.

20. The system of claim 12, wherein communications between at least two of the seller, the buyer, the third party, and a delivery system operator is conducted over at least one of regular mail, e-mail, facsimile, internet, and an interactive voice response system

21. The system of claim 12, wherein the item comprises at least one of the following: a mailpiece, a United States Postal Service Priority Mail package, and a United States Postal Service Express Mail Package.

22. The system of claim 12, further comprising utilizing as a tracking indicia at least one of the following: a bar code and a PLANET code.

23. A method for providing item delivery service with a return component, comprising:
arranging, by a third party, a sales transaction of an item between a seller and a buyer, utilizing at least one of the following, regular mail, e-mail, facsimile, internet, and an interactive voice response, in arranging the sales transaction, arranging the sales transaction further comprising;
receiving authorization from the buyer to transfer a payment from a buyer account for the purchase of the item, the buyer account comprising at least one of billing the buyer, a buyer's checking account, a buyer's credit card account, a buyer's debit card account, and cash from the buyer,
debiting the buyer account in the amount of the payment, and
crediting an escrow account in the amount of the payment;
delivering the item to the buyer utilizing a delivery system using at least one of a mailpiece, a United States Postal Service Priority Mail package, and a United States Postal Service Express Mail Package in delivering the item, delivering the item further comprising;
notifying the seller by the third party that the item can be shipped,
receiving by the third party a request from the seller for a tracking indicia, the tracking indicia comprising at least one of a bar code and a PLANET code,
sending the tracking indicia to the seller from the third party,
receiving the item into the delivery system, the item containing the tracking indicia,
scanning the tracking indicia, and
providing the third party with the data contained in the tracking indicia;
making a payment for at least one of the following: a purchase price of the item to the seller, a delivery fee, and a fee for any other buyer-selected delivery-related services if the buyer decides to keep the item after an inspection of the item; and
returning the item to the seller through the delivery system if the buyer determined not to keep the item, the third party providing the buyer with a return label, returning the item if the buyer determined not to keep the item further comprising;
receiving the item into the delivery system, the item containing the tracking indicia, and
making the payment of the purchase price of the item to the buyer when the tracking indicia is scanned upon delivery of the item to the seller.

24. A method for providing item delivery service with a return component, comprising:
delivering the item to the buyer utilizing a delivery system;
receiving a payment from a person-to-person payment system for at least one of the following: a delivery fee, and a fee for any other buyer-selected delivery-related services based at least upon a determination by the buyer as to whether to keep the item after an inspection of the item; and
returning the item to the seller through the delivery system if the buyer determined not to keep the item, the item including a return label provided by the person-to-person payment system.

25. The method of claim 24, wherein the delivering stage further comprises:
receiving the item into the delivery system, the item containing a tracking indicia;
scanning the tracking indicia; and
providing the person-to-person payment system with the data contained in the tracking indicia.

26. The method of claim 24, wherein, if the buyer determined not to keep the item, the returning stage further comprises:
receiving the item into the delivery system, the item containing a tracking indicia; and
providing the person-to-person payment system with data when the tracking indicia is scanned upon delivery of the item to the seller.

27. The method of claim 24, further comprising utilizing at least one of the following media: regular mail, e-mail, facsimile, internet, and an interactive voice response method in arranging the sales transaction.

28. A system for providing item delivery'service with a return component, comprising:
a component for delivering the item to the buyer utilizing a delivery system;
a component for receiving a payment from a person-to-person payment system for at least one of the following: a delivery fee, and a fee for any other buyer-selected delivery-related services based at least upon a determination by the buyer as to whether to keep the item after an inspection of the item; and
a component for returning the item to the seller through the delivery system if the buyer determined not to keep the item, the item including a return label provided by the person-to-person payment system.

29. The system of claim 28, wherein the component for delivering further comprises:
a component for receiving the item into the delivery system, the item containing a tracking indicia;
a component for scanning the tracking indicia; and
a component for providing the person-to-person payment system with the data contained in the tracking indicia.

30. The system of claim 28, wherein, if the buyer determined not to keep the item, the component for returning further comprises:
a component for receiving the item into the delivery system, the item containing a tracking indicia; and
a component for providing the person-to-person payment system with data when the tracking indicia is scanned upon delivery of the item to the seller.

31. The system of claim 28, further comprising utilizing at least one of the following media: regular mail, e-mail, facsimile, internet, and an interactive voice response system in arranging the sales transaction.
